(19) United States
(12) Patent Application Publication
(10) Pub. No.: US 2005/0122425 A1
(43) Pub. Date: Jun. 9, 2005

(54) [ELECTRONIC DEVICE FOR CAPTURING AND SHOWING IMAGES AND PALM-TOP DEVICE]

(76) Inventors: Den-Jen Hwung, Hsinchu City (TW); Te-Sung Su, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/710,076

(22) Filed: Jun. 17, 2004

(30) Foreign Application Priority Data
Dec. 9, 2003 (TW) 92134651

(51) Int. Cl. H04N 5/222; G02F 1/1345; H04N 5/225

(52) U.S. Cl. 348/376; 348/333.01

(57) ABSTRACT

An electronic device for capturing and showing images is provided. The electronic device comprises a photosensitive chip and a display screen. The photosensitive chip has a photosensitive area adapted for capturing images. The photosensitive area has a rectangular shape with a first height and a first width. The aspect ratio of the first width to the first height is smaller than 1. The display screen is adapted to output the images captured by the photosensitive chip. The display screen has a rectangular shape with a second height and a second width. The aspect ratio of the second width to the second height is smaller than 1.

### CROSS REFERENCE TO RELATED APPLICATIONS

This application claims the priority benefit of Taiwan application serial no. 92134651, filed Dec. 9, 2003.

### BACKGROUND OF INVENTION

1. Field of the Invention

The present invention relates to an electronic device for capturing and showing images. More particularly, the present invention relates to an electronic device having a photosensitive chip with the aspect ratio smaller than 1, and the photosensitive chip has a dimension that corresponds to the dimension of a display screen.

2. Description of the Related Art

With the digitization of electronic data, information can be transmitted far and wide through a digital network system. Anyone in possession of a portable device and linked to a network system may access digital data with ease. In general, a photosensitive chip is normally used to capture image data and then the captured image data is displayed on a display screen. However, the conventional technique often produces a photosensitive chip with the aspect ratio of width to height greater than 1 while a display screen of the conventional palm-top electronic device has the aspect ratio of width to height smaller than 1. Hence, if the images captured by the photosensitive chip is to be displayed on a display screen, a portion of the image along the lateral dimension must be sacrificed or else the size of the image must be reduced such that the entire image can be fitted inside the display screen.

FIG. 1 is a diagram showing a conventional method of fitting an image captured by a photosensitive chip on a display screen. The image display screen 110 as shown in FIG. 1 is a device for displaying an image 120 captured by a photosensitive chip (not shown). Most image display screen 110 used in a palm-top electronic device has a width-to-height aspect ratio smaller than 1. However, the width-to-height aspect ratio of the photosensitive chip is greater than 1. Therefore, to display the image 120 captured by the photosensitive chip on the display screen 110, a section of the area on the left and right side of the image 120 (the area on the left and right side marked by single slash lines) must be deleted. In other words, the display screen 110 can only display the central portion of the image 120 (the area in the middle indicated by crosshatched lines). The pixels on the left and the right side of the photosensitive chip are invalid because the image 120 captured by the pixels thereon will not be displayed on the display screen 110. Consequently, some resources are wasted unnecessarily.

FIG. 2 is a diagram showing an alternative method of fitting an entire image captured by a photosensitive chip on a display screen. As shown in FIG. 2, the entire captured image 130 is fitted inside the display screen 110 by reducing the size of the image 130. Although the entire image 130 is now displayed on the display screen 110, the reduction in the size of the image 130 leads to a drop in the identification and clarity. Moreover, the reduced image 130 is shown only in a central portion of the display screen 110 (the area with the crosshatched lines) and nothing is displayed on the upper and lower areas of the display screen 110. In other words, the displayable upper and lower portions of the display screen 110 (the areas with single slash lines) are not used.

### SUMMARY OF INVENTION

Accordingly, at least one objective of the present invention is to provide an electronic device for capturing and displaying images and a palm-top electronic device that has a photosensitive chip with a width-to-height aspect ratio smaller than 1 to match the dimension of an image display screen. Thus, the image captured by all of the pixels on the photosensitive chip can be substantially shown on the display screen without sacrificing some displayable area of the display screen.

To achieve these and other advantages and in accordance with the purpose of the invention, as embodied and broadly described herein, the invention provides an electronic device for capturing and displaying images. The electronic device comprises at least a photosensitive chip and a display screen. The photosensitive chip has a photosensitive area adapted for capturing images. The photo-sensitive area has a rectangular shape with a first height and a first width. The aspect ratio of the first width to the first height is smaller than 1. The display screen is adapted to output the images captured by the photosensitive chip. The display screen has a rectangular shape with a second height and a second width. The aspect ratio of the second width to the second height is smaller than 1.

The aspect ratio of the first width divided by the first height is preferably equal to the aspect ratio of the second width divided by the second height and the photosensitive chip is a CMOS image sensor, for example.

In brief, through a change in the dimension of the photo-sensitive area of the photosensitive chip according to the present invention, the width-to-height aspect ratio of the photosensitive area is smaller than 1, the width-to-height aspect ratio of photosensitive chip is proportional to that of the display screen. Because the dimensions of the image from the photosensitive chip are proportional to the dimensions of the display screen, unused pixels on the photosensitive chip or unused displayable areas on the display screen can be substantially avoided.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram showing a conventional method of fitting an image captured by a photosensitive chip on a display screen.

FIG. 2 is a diagram showing an alternative conventional method of fitting an entire image captured by a photosensitive chip on a display screen.

FIG. 3 is a diagram showing an electronic device adapted for capturing images and transmitting image data according to a first preferred embodiment of the present invention. The drawing enclosed by the dash line in the upper portion of FIG. 3 is a front magnified view of the photosensitive chip.

FIG. 4 is a schematic diagram showing an output image and a display screen according to the first preferred embodiment of this invention.

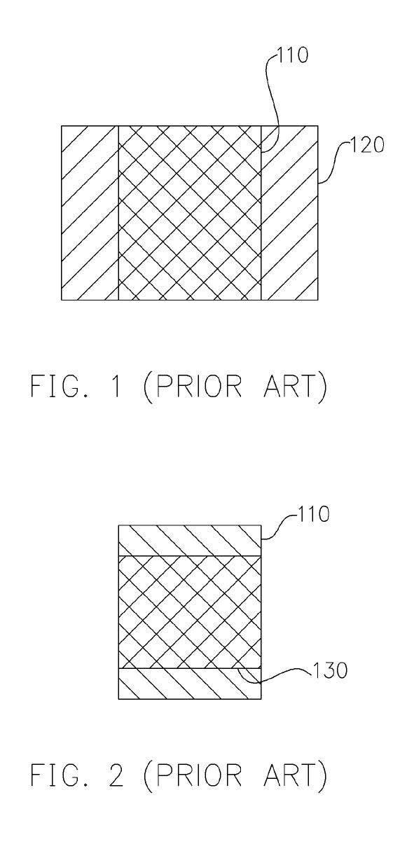

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

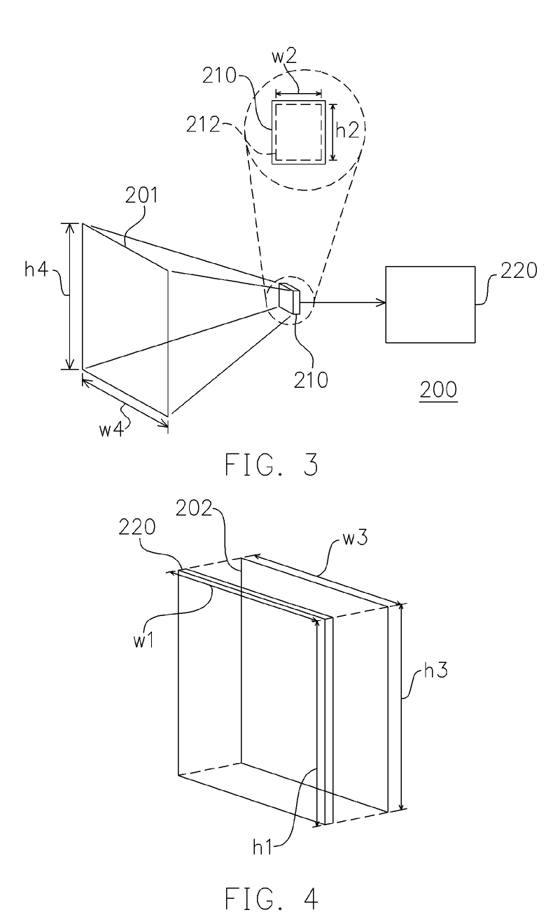

FIG. 3 is a diagram showing an electronic device adapted for capturing images and transmitting image data according to a first preferred embodiment of the present invention. The drawing enclosed by the dash line in the upper portion of FIG. 3 is a front magnified view of the photosensitive chip. FIG. 4 is a schematic diagram showing an output image and a display screen according to the first preferred embodiment of this invention. As shown in FIGS. 3 and 4, the electronic device 200 essentially comprises a photosensitive chip 210 and a display screen 220. An image 201 is captured by the photosensitive chip 210 and then displayed on the display screen 220.

In the present invention, the electronic device 200 is a palm-top electronic device such as a mobile phone or a personal digital assistant (PDA). In general, the display screen 220 has a rectangular shape with a height h1 and a width w1. Typically, the height h1 is greater than the width w1 so that the aspect ratio obtained by dividing the width w1 by the height h1 is smaller than 1. To fit the image 202 to the display screen 220, the dimensions of the photosensitive area 212 on the photosensitive chip 210 should be modified.

The photosensitive chip 210 has a photosensitive area 212 for capturing an image 201. The photosensitive area 212 can be an array of photo-diodes (not shown) each operating as a reverse-biased p-n junction. The photosensitive chip 210 is a CMOS image sensor, for example. It should be noted that the photosensitive region 212 of the photosensitive chip 210 according to the present invention has a rectangular shape. The photosensitive area 212 has a height h2 and a width w2 and the aspect ratio obtained by dividing the width w2 by the height h2 is smaller than 1. Thus, the image captured by the photosensitive area 212 has a width w4 to height h4 aspect ratio smaller than 1.

Ideally, the width-to-height aspect ratio (w2/h2) of the photosensitive area 212 is substantially equal to the width-to-height aspect ratio (w1/h1) of the display screen 220. Because the dimensions of the images output from the photosensitive chip 210 match the dimensions of the display screen 220, the width w3 and height h3 of the image 202 almost match the width w1 and the height h1 of the display screen 220. In other words, the width-to-height aspect ratio (w3/h3) of the image 202 and the width-to-height aspect ratio (w1/h1) of the display screen 220 are substantially equal to or smaller than 1.

In summary, the present invention modifies the dimension of the photosensitive area 212 of the photosensitive chip 210 in such a way that the aspect ratio (w2/h2) is smaller than 1 and substantially equal to the aspect ratio (w1/h1) of the display screen 220. Because the dimensions of the image 202 from the photosensitive chip 210 are substantially equal to the dimensions of the display screen 220, unused pixels on the photosensitive chip or unused displayable areas on the display screen are substantially avoided.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An electronic device for capturing and displaying images, comprising:
a photosensitive chip having a photosensitive area for capturing images, wherein the photosensitive area has a rectangular shape with a first height and a first width, and the aspect ratio of the first width to the first height is smaller than 1; and
a display screen for displaying the images captured by the photosensitive chip, wherein the display screen has a rectangular shape with a second height and a second width, and the aspect ratio of the second width to the second height is smaller than 1.

2. The electronic device of claim 1, wherein the aspect ratio obtained by dividing the first width by the first height is substantially equal to the aspect ratio obtained by dividing the second width by the second height.

3. The electronic device of claim 1, wherein the photo-sensitive chip is a CMOS image sensor.

4. A photosensitive chip for capturing an image having a rectangular shape with a first height and a first width such that the aspect ratio obtained by dividing the first width by the first height is smaller than 1, characterized in that:
the photosensitive chip has a photosensitive area, wherein the photosensitive area has a rectangular shape with a second height and a second width, and the aspect ratio obtained by dividing the second width by the second height is smaller than 1.

5. The photosensitive chip of claim 4, wherein the photosensitive chip is a CMOS image sensor.

6. A palm-top electronic device for capturing and displaying images, comprising:
a photosensitive chip having a photosensitive area for capturing an image; and
a display screen suited for showing the entire image captured by the photosensitive chip and the entire image shown from all the display screen, wherein the display screen has a rectangular shape with a first height and a first width such that the aspect ratio obtained by dividing the first width by the first height is smaller than 1.

7. The palm-top electronic device of claim 6, wherein the photosensitive area of the photosensitive chip has a rectangular shape with a second height and a second width and the aspect ratio obtained by dividing the second width by the second height is smaller than 1.

8. The palm-top electronic device of claim 7, wherein the aspect ratio obtained by dividing the first width by the first height is substantially equal to the aspect ratio obtained by dividing the second width by the second height.

9. The palm-top electronic device of claim 6, wherein the photosensitive chip is a CMOS image sensor.

10. The palm-top electronic device of claim 6, wherein the palm-top electronic device is a mobile phone or a personal digital assistant (PDA).
